(19) United States
(12) Patent Application Publication
(10) Pub. No.: US 2017/0223060 A1
(43) Pub. Date: Aug. 3, 2017

(54) SECURITY CONTROL

(71) Applicant: HEWLETT PACKARD ENTERPRISE DEVELOPMENT LP, Houston, TX (US)

(72) Inventor: Dennis Hayes, Tulsa, OK (US)

(21) Appl. No.: 15/500,892

(22) PCT Filed: Sep. 29, 2014
(86) PCT No.: PCT/US2014/057971

§ 371 Date: Jan. 31, 2017

(30) Foreign Application Priority Data
Aug. 28, 2014 (IN) 4213/CHE/2014

(51) Int. Cl. H04L 29/06; H04L 12/22

(52) U.S. Cl. CPC H04L 63/205; H04L 12/22; H04L 63/107; H04L 63/164; H04L 63/20; H04L 63/10

(57) ABSTRACT

Some implementations may include obtaining a security control configuration for a pair of endpoints for a security control type. A virtual security control instance of the security control type may be assigned to the pair of endpoints. The virtual security control instance may be configured according to the security control configuration. A software defined network may be configured to forward packets from one of the endpoints to the other one of the endpoints through the virtual security control instance.

### BACKGROUND

Network perimeter security controls provide safeguards or countermeasures to avoid, or counteract security risks to computer networks and network-accessible resources. Network security controls may be implemented as network hardware devices or as software residing on network attached computers. Examples of security controls include firewalls, anti-spam systems, anti-virus systems, intrusion prevention or detection systems, web application firewalls. Extensible Markup Language (XML) gateways, deep packet inspection firewalls, next generation firewalls, website filters, Quality-of-Service (QoS) managers, and application inspection and control systems.

### BRIEF DESCRIPTION OF THE DRAWINGS

Certain examples are described in the following detailed description and in reference to the drawings, in which:

FIG. 1 illustrates an example method for assigning virtual security controls and correspondingly configuring a software defined network (SDN);

FIG. 2 illustrates an example method of establishing multiple security controls for a pair of endpoints and configuring an SDN accordingly;

FIG. 3 illustrates an example system provisioned as described with respect to FIG. 2;

FIG. 4 illustrates an example implementation of a system utilizing load balancing;

FIG. 5 illustrates an example system including a provisioning tool to provision security control instances for endpoints;

FIG. 6 illustrates an example system including a monitor; and

FIG 7 illustrates an example computer including a non-transitory computer readable medium storing instructions executable to configure sets of security control instances and configure a software defined network.

### DETAILED DESCRIPTION OF SPECIFIC EXAMPLES

Selection of security controls, in terms of the appropriate set of controls and the baseline configuration of each control, that it appropriate to address the risk to an organization for the confidentiality, integrity, and availability of information are application-specific. Sharing security controls between multiple applications with multiple message streams may be complex and error-prone. Sharing security controls may require ensuring that the appropriate inheritable policies are in place and any non-shared policies apply only to their intended message streams. Additionally, the coordination of policies across multiple controls may complicate the process further, requiring validation that the policies are correct, do not negate or invalidate other policies, and do not duplicate the protection offered by other controls.

Aspects of the disclosed technology may implement security controls and an underlying network switch infrastructure virtually and provision only those controls that are required between a single pair of endpoints. Additionally, aspects of the disclosed technology may allow the controls between endpoints to be specifically configured for the endpoints. This may avoid some complications associated with shared security controls.

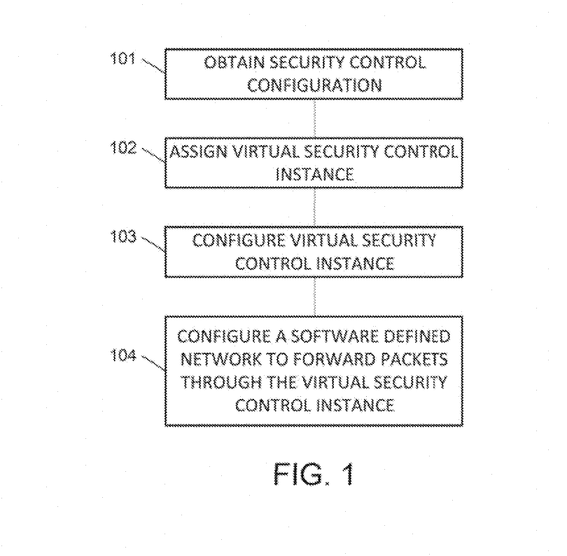

FIG. 1 illustrates an example method for assigning virtual security controls and correspondingly configuring a software defined network (SDN). For example, the illustrated method may be performed by a network security orchestration system to implement a security gateway using one or more servers.

The example method may include block 101. Block 101 may include obtaining a security control configuration for a pair of endpoints for a security control type. The endpoints may be any source and destination for packets. For example, the endpoints may be a server and a client, such as a web server and browsers, or email server and email client. As another example, the endpoints may be peers engaging in peer-to-peer transmissions. As a further example, the endpoints may be application components in a service oriented architecture, such as a web tier component, a business logic tier component, or database tier component.

The security control type may be any type of security control used to provide security for the endpoints. For example, the type of security control may include firewalls, anti-spam systems, anti-virus systems, intrusion prevention or detection systems, web application firewalls, Extensible Markup Language (XML) gateways, packet inspection firewalls, next generation firewalls, website filters, Quality-of-Servica (QoS) managers, and application inspection and control systems.

In some implementations, the security control configuration may be obtained from a system administrator. For example, the security control configuration may be obtained using a configuration tool providing an interface to allow the administrator to input the security control configuration. In other implementations, the security control configuration may be obtained by retrieval from storage or by receipt from an automated network operations system.

The security control configuration may define the policies specific to the security control type that will be applied to packets sent from one of the endpoints to the other. For example, the security control configuration may include a set of settings for the type of security control to be implemented. For example, in a deny by default/allow by exception boundary control, the permitted exceptions may be tailored to the specific endpoints to which the control applies. For example, port 80 for HTTP, port 443 for HTTPS, or port 23 for Telnet may be allowed to one application, but not allowed to others. Thus, the configuration of these controls may provide fine-grained control over the degree or type of protection aforded each application. In further examples, the security control configuration may be formatted according to the control selection and configuration portion of the Risk Management Framework process described in National Institute of Standards and Technology (NIST) documentation and systems management recommendations outlined in the Information Technology Information Library (ITIL)

In some implementations, the security control configuration may also define how many instances of the security control type will be allocated to the endpoints. For example, based on message load, multiple instances of the same type may be allocated to the endpoints and load balancing may be used to distribute messages between the instances.

The example method may also include block 102. Block 102 may include assigning a virtual security control instance of the security control type to the pair of endpoints. The virtual security control instance may be a specific instance of the type of security control allocated for the pair of endpoints. For example, the virtual security control instance may be a firewall running on a virtual machine that is dedicated to the pair of endpoints.

In some cases, assigning the virtual security control instance may include selecting a virtual security control instance from a group of pre-instantiated virtual security control instances. For example, a set of virtual machines may be instantiated on one or more hypervisors and may execute a set of virtual security control instances of the virtual security control type. In other cases, assigning the virtual security control instance may include instantiating a virtual security control instance from a stored template. For example, a virtual machine image executing the security control image may be instantiated in a hypervisor.

In some implementations, block 102 may include assigning multiple virtual security control instances of the security control type to the pair of endpoints. For example, this may be done in conjunction with load balancing to reduce the processing load on any one virtual security control instance.

The example method may also include block 103. Block 103 may include configuring the virtual security control instance assigned in block 102. For example, block 103 may include configuring the virtual security control instance according the security control configuration obtained in block 101. For example, block 103 may include configuring the virtual security control instance by setting the policies contained in the security control configuration.

The example method may also include block 104. Block 104 may include configuring a software defined network to forward packets from one of the endpoints to the other one of the endpoints through the virtual security control instance. For example, block 104 may include providing information regarding the endpoints and the virtual security control instance to an SDN controller. This may enable the SDN controller to provide flow rules to the SDN switches it controls to forward packets from one of the endpoints to the other through the virtual security control instances. As another example, block 104 may include establishing flow rules for switches of the SDN and transmitting the flow rules to the switches, directly or via an SDN controller.

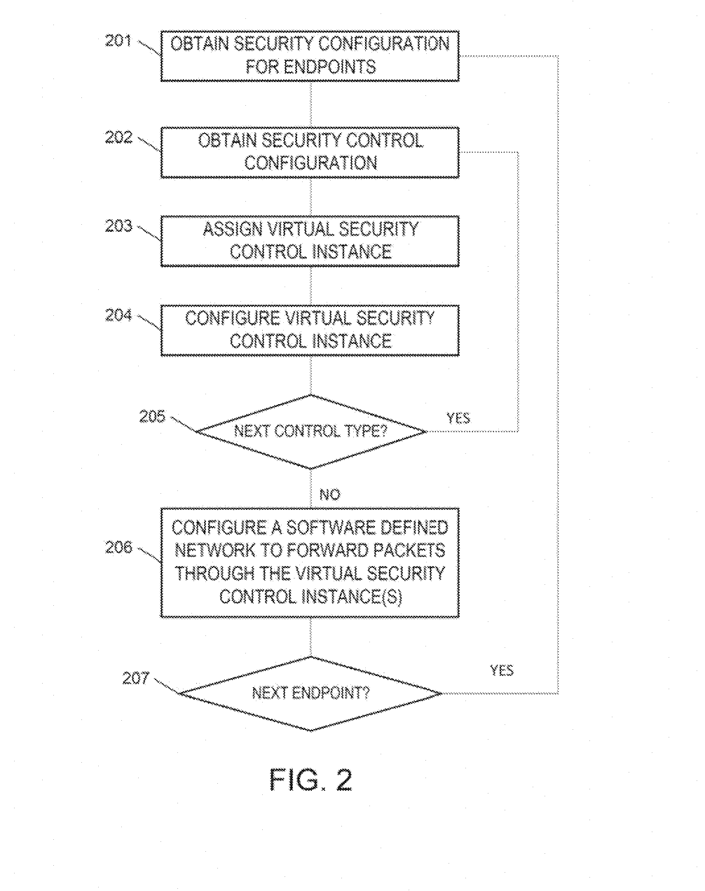

FIG. 2 illustrates an example method of establishing multiple security controls for a pair of endpoints. In some implementations, multiple different types of security controls may be established for different types of endpoints. For example, a set of security controls may be established to protect an email application within a network. The set of security controls the email application may include a firewall, an anti-spam application, and an anti-virus application. As another example, a set of security controls for a web application and user may include a firewall, an intrusion prevention or detection application, and a web application firewall (WAF). Security controls for a web application that communicates by using XML messages might include a firewall, an intrusion prevention or detection application, a WAF, and an XML gateway. As another example, a client-server application may have incoming messages forwarded through a firewall and an intrusion prevention or detection application.

The example method may include block 201. Block 201 may include obtaining a security configuration for the pair of endpoints. The security configuration may include information determining which controls are to be applied and the settings or policies for each of the controls. For example, the security configuration may include a list of control types to be implemented, and a security control configuration for each type listed. Additionally, in some implementations, the security configuration may define the order that the controls should be applied to incoming messages. For example, for security controls monitoring incoming email messages it may be more efficient to have an anti-spam filter prior to an anti-virus detection system. In some cases, a security control may be shared between two message streams. For example, messages intended for the same server from two different clients may share some or all of their security control instances. In these cases, the security configuration may also indicate whether a shared or unique instance of each control is permissible for the pair being provisioned.

In some implementations, block 201 may be performed by obtaining the security configuration from a system administrator. For example, block 201 may be performed using a system configuration tool. As another example, block 201 may be performed by retrieving the security configuration from storage, or receiving the security configuration from a network orchestrator or operations support system.

The example method may also include block 202. Block 202 may include obtaining a security control configuration for a security control type from the security configuration obtained in block 201.

The example method may further include block 203. Block 203 may include assigning a virtual security control instance of the type associated with the configuration obtained in block 202. For example, block 203 may be performed as described with respect to block 102 of FIG. 1.

The example method may further include block 204. Block 204 may include configuring the virtual security control instance assigned in block 203 according to the security control configuration obtained in blck 202. For example, block 204 may be performed as described with respect to block 103 of FIG. 1.

The example method may also include block 205. Block 205 may include determining if there is another control type in the security configuration obtained in block 201. If so, the method may repeat block 202 until a virtual security control instance has been configured for each security control type in the security configuration.

The example method may also include block 206. Block 206 may include configuring the SDN to forward packets through the set of virtual security control instances configured by performing blocks 201-205. For example, block 206 may be performed as described with respect to block 104 of FIG. 1. If the security configuration includes an ordering for the security control instances, block 206 may include configuring the SDN to forward packets through the set of instances in the order defined in the security configuration.

The example method may also include block 207. In block 207, the system may determine if there are further endpoints for which to provision security controls. If so, the method may repeat from block 201 for each pair of endpoints.

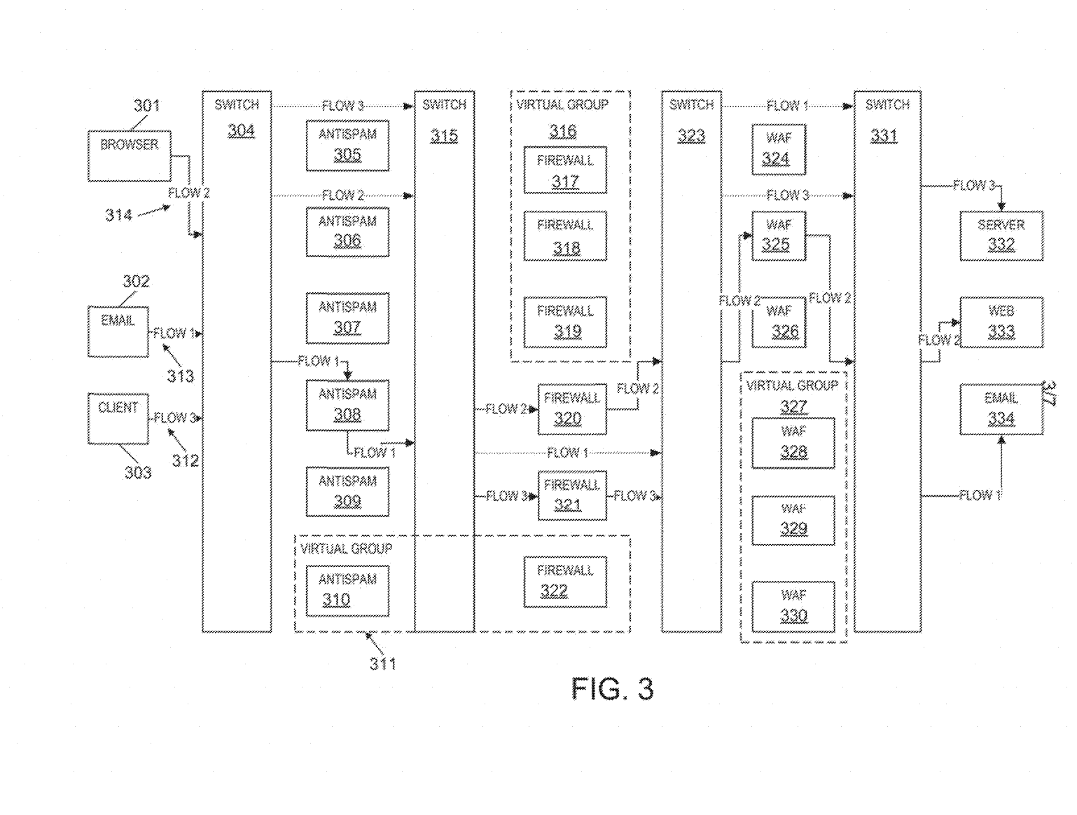

FIG. 3 illustrates an example system provisioned as described with respect to FIG. 2. The illustrated example includes three endpoints 301-303 having message flows to three other endpoints. For example, a browser 301 having a flow 314 to a web server 333, an email application having a flow 313 to an email server 334, and a user application 303 having a flow 312 a server 332. The system further includes an SDN switch fabric 304, 315, 323, 331 configured to forward packets of the different flows through their respective security controls.

As an example, the system may include a set of anti-spam controls 305-310 instantiated on virtual machines on various physical devices. In this example, switch 304 is configured to forward flow 313 to anti-spam control 308. Control 308 is configured to forward packets to switch 315. The remaining switch fabric 315, 323, 331 is configured to forward packets to email server 334. Accordingly, email messages are not subjected to unnecessary security controls.

In some cases, the controls 305-310 may instantiated on the same physical devices, each may be instantiated on a different physical device, or any other configuration. For example, each control 305-310 may be installed on a separate blade of a blade server enclosure. As another example, a control 305-310 may be instantiated on the same system as the endpoint it protects. In the illustrated example, controls 305-309 are instantiated and provisioned to provide security to a network endpoint.

In this example, flow 314 from browser 301 is forwarded by switch 304 through the switch fabric to switch 315, which is configured to forward packets to firewall instance 320. Firewall instance 320 is configured to forward packets to switch 323. Switch 323 is configured to forward packets of flow 314 to WAF 325. WAF 325 is configured to forward packets to switch 331, which is configured to forward packets to web server 333.

In the illustrated example, flow 312 from the client application 303 is forwarded through the switch fabric to firewall 321 and then to server 332. As described above, firewall 321 may be configured according to a security control configuration specific to the application 332. Similarly, firewall 320 may be configured according to a security control configuration specific to the application 333. These configurations may differ from each other. For example, application 333 may provide more security features than application 332. Accordingly, firewall 321 may be configured to avoid providing them the same features as provided by application 333. As another example, WAF 325 may check for SQL injection. WAF 324 may be provisioned for a web server that natively protects against SQL injection. Accordingly, WAF 324 may be configured not to check for SQL injection.

In the illustrated example, control instances that are not provisioned are provided in virtual groups 311, 316, 327. In some cases, a virtual group 311 may include instances of different types. For example, instances of those groups may be reserved for applications that benefit from controls of each different type. In other cases, a virtual group 316, 327 contains instances of the same type. The instances 317-319, 328-330 may be provisioned as needed when new endpoints join the network, or when message load increases and load balancing will be applied.

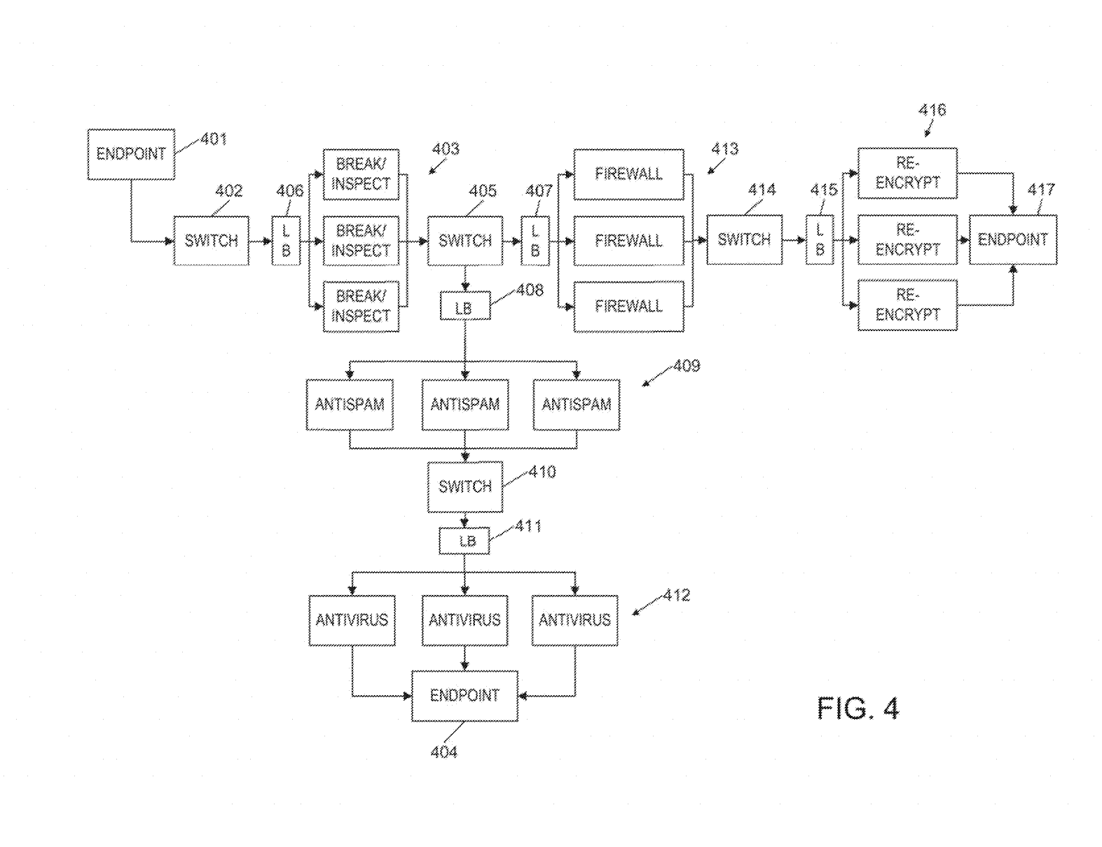

FIG. 4 illustrates an example implementation of a system utilizing load balancing. In some implementations, expanding or contracting the number of controls may be determined by the immediate message load and performed by the provisioning system. For example, the methods of FIG. 1 or FIG. 2 may be performed to expand the number of security control instances upon an increase in message load. In some examples, the implementation of load balancing may include provisioning separate virtual load balancer appliances and configuring the SDN switches with rules to forward flows to the load balancers. In other example, load balancing may be implemented as a feature of the SDN. For example, SDN switches may be configured with flow rules by an SDN controller to implement load balancing by distributing incoming packets amongst copies of security controls.

In the illustrated example, messages from a first endpoint 401 to a second endpoint 404 are forwarded through a decryption break/inspect component 403, an anti-spam control 409, and an antivirus control 412. Messages from the first endpoint 401 to a third endpoint 417 are forwarded through the decryption component 403, a firewall control 413, and a re-encryption component 416.

For example, switch 402 may be configured to forward all packets from endpoint 401 to a load balancer 406 which distributes the packets to an instance of the break/inspect component 403. Switch 405 may be configured with flow rules that differentiate between packets for endpoint 404 and endpoint 417.

Packets for endpoint 404 may be forwarded to load balancer 408. Load balancer 408 may distribute packets to one of the instances of anti-spam control 409, which then sends the packets to switch 410. Switch 410 may send the packets to load balancer 411, which distributes the packets to instances of the antivirus control 412 before the packets are forwarded to the endpoint 404.

Packets for endpoint 417 may be forwarded to load balancer 407. Load balancer 407 may distribute panels to instances of the firewall control 413, which sends packets to switch 414. Switch 414 may forward packets to load balancer 415, which distributes packets to instances of re-encryption control 416 before the packets are forwarded to endpoint 417.

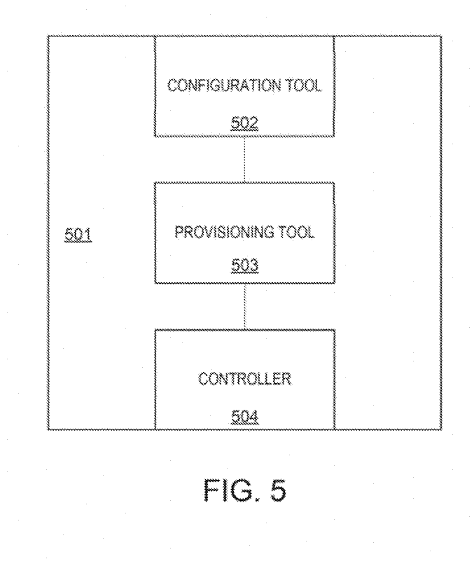

FIG. 5 illustrates an example system 501 including a provisioning tool 501 to provision security control instances for endpoints. For example, the illustrated system 501 may be implemented using hardware components, software stored on a non-transitory computer readable medium and executed by a processor, or a combination thereof. For example, the illustrated components may be components of a security gateway control system.

The system may include a configuration tool 502. The configuration tool 502 may be to obtain a security configuration for messages to an endpoint. For example, the security control configuration may define a set of security controls to operate on the messages and security control configurations of the set of security controls. In some implementations, the configuration tool 502 may perform block 201 of FIG. 2. For example, the configuration tool 502 may provide a user interface to allow an administrator to input configurations.

The system may further include a provisioning tool 503. The provisioning tool may assign, for each respective security control of the set of security controls, an instance of the respective security control. Additionally, the provisioning tool may configure each instance according the respective security control configuration. For example, the provisioning tool may perform steps 202-204 of FIG. 2 for each security control of the set.

In some implementations, the provisioning tool 503 may assign each instance by selecting an instantiated template virtual security control or by instantiating a stored template virtual security control. In further implementations, the provisioning tool 503 may instantiate a security control instance for the set of security control instances to satisfy only policy requirements for the corresponding security control. Accordingly, each security control instance may be specific to the endpoint. In further implementations, each security control instance is specific to the two endpoints exchanging messages.

The system may further include a controller 504. The controller 504 may implement a path in a software defined network for the messages through the set of security control instances. For example, the controller 504 may be an SDN network controller or may communicate with an SDN network controller to provision a set of flow rules to implement the path. For example, the controller may perform step 206 of FIG. 2.

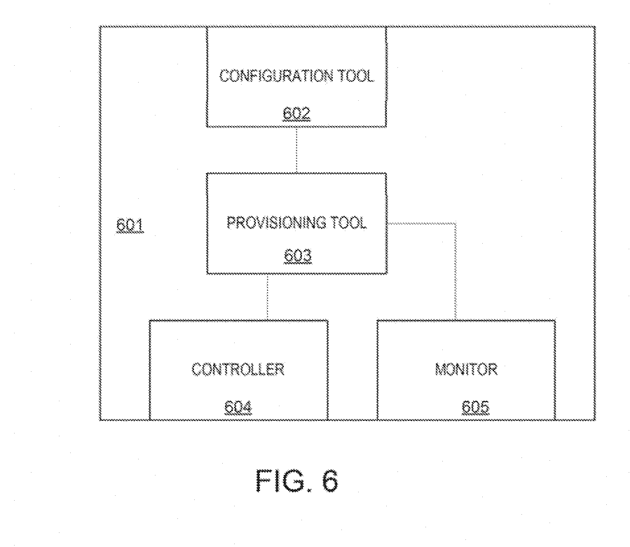

FIG. 6 illustrates an example system including a monitor 605. Similarly to FIG. 5, the illustrated system 601 may be implemented using hardware components, software stored on a non-transitory computer readable medium and executed by a processor, or a combination thereof. For example, the illustrated components may be components of a security gateway control system.

The example system may include a configuration tool 602, a provisioning tool 603, and a controller 604. These components may be as described with respect to configuration tool 502, provisioning tool 503, and controller 504 of FIG. 5.

Additionally, the example system 601 may include a monitor 605. The monitor 605 may monitor the flows implemented by the flow rules in the software defined network. Additionally, the monitor 605 many monitor the operations of the set of security control instances. For example, the monitor 605 may monitor the security system to provide assurance that each control was started successfully and accepted the configuration it was supplied. Additionally, the monitor may provide an interface to support queries regarding performance, capacity, inbound or outbound queue depth, or other operational factors. In some implementations, the monitor 605 may provide a graphical interface. Information about the status of the controls, such as which controls are configured, the message load passing through them, the performance characteristics of the each, and the total path may be shown in a diagram. For example, this information may be overlaid on a diagram similar to FIGS. 3 or 4. The flows through the series of controls, switches, load balancers, and other devices, may be represented in color. As an example, increasing level of detail may be obtained by mousing over or clicking on components or sections, by hand or finger gestures, or other interface methods.

In additional implementations, the monitor 605 may monitor the message load through the security control instances. Upon meeting various load criteria, the monitor 605 may instruct the provisioning tool to assign additional security control instances with the appropriate configurations. For example, as described with respect to FIG. 4, a set of security control instances all configured with the same configuration may be used to handle larger message loads.

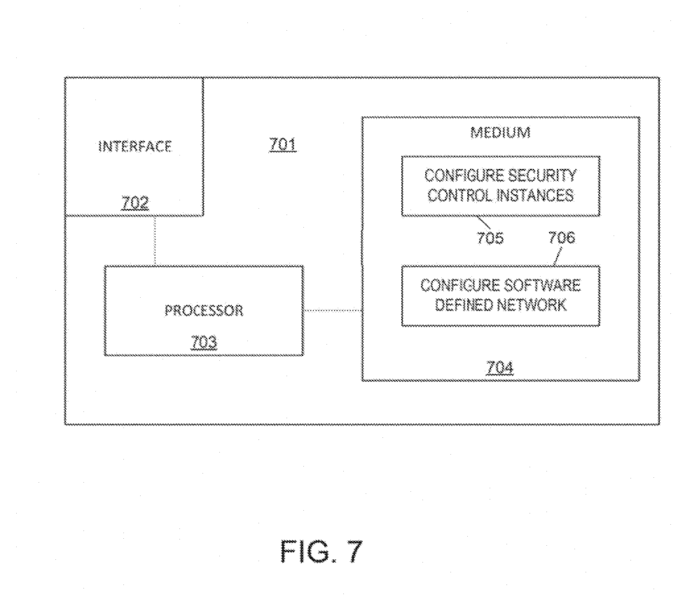

FIG. 7 illustrates an example computer 701 including a non-transitory computer readable medium 704 storing instructions executable to configure sets of security control instances and configure a software defined network. For example, the non-transitory computer readable medium 704 may include storage, memory, or a combination thereof. For example, the example computer of FIG. 7 may be an implementation of a security gateway system, such as a system 501 of FIG. 5 or a system 601 of FIG. 6.

In the illustrated example, the medium 704 may store instructions 705. Instructions 705 may be executable by a processor 703 to configure a first set of security control instances according to a first security configuration for a first endpoint. Addtionally, instructions 705 may be executable by the processor 703 to configure a second set of security control instances according to a second security configuration for a second endpoint. For example, the instructions 705 may be executable by the processor 703 to transmit configurations for the instances via a network interface 702.

In some implementations, the instructions 705 may be further executable by the processor 703 to assign the sets of security control instances according the security configurations. For example, the instructions 705 may be executable to assign the first set of security control instances according to the first security configuration and assign the second set of security control instances according to the second security configuration.

The medium 704 may also store instructions 706. Instructions 706 may be executable by the processor 703 to configure a software defined network to forward packets to the first endpoint through the first set of security control instances and to forward packets to the second endpoint through the second set of security control instances. For example, the instructions 706 may be executable by the processor to configure the software defined network by transmitting flow rules directly to SDN switches or by transmitting instructions to an SDN controller.

In some implementations, the security configurations apply in a many-to-one manner, so that the security configurations are specific to a message destination and apply to any message source. In other implementations, the security configurations apply pairwise to pairs of endpoints. In these implementations, the instructions 705 may be executable to configure a third set of security control instances according to a third security configuration for the first endpoint and a fourth endpoint. Additionally, the instructions 706 may be executable to configure the software defined network to forward packets from the fourth endpoint to the first endpoint through the third set of security control instances.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method, comprising:
obtaining a security control configuration for a pair of endpoints for a security control type;
assigning a virtual security control instance of the security control type to the pair of endpoints;
configuring the virtual security control instance according to the security control configuration;
configuring a software defined network to forward packets from one of the endpoints to the other one of the endpoints through the virtual security control instance.

2. The method of claim 1, further comprising:
assigning the virtual security control instance by selecting the virtual security control instance from a set of instantiated virtual security control templates.

3. The method of claim 1, further comprising:
assigning the virtual security control instance by instantiating the virtual security control instance from a stored virtual security control template.

4. The method of claim 1, wherein the virtual security control instance implements a set of security policies specific to the pair of endpoints.

5. The method of claim 1, further comprising:
obtaining a security configuration for the pair of endpoints, the security configuration indicating a plurality of security control types for the pair of endpoints and a corresponding plurality of security control configurations for each security control type;
for each respective security control type, configuring a virtual security control instance according to the security control configuration for the respective security control type.

6. The method of claim 5, wherein the security configuration indicates whether to use a unique or shared instance of a security control for each security control type.

7. The method of claim 1, further comprising:
obtaining a second security control configuration for a second pair of endpoints for the security control type;
assigning a second virtual security control instance of the security control type;
configuring the second virtual security control instance according to the second security control configuration; and
configuring the software defined network to forward packets from one of the second pair of endpoints to the other one of the second pair of endpoints through the second virtual security control instance.

8. A system, comprising:
a configuration tool to obtain a security configuration for messages to an endpoint, the security control configuration defining a set of security controls to operate on the messages and security control configurations of the set of security controls;
a provisioning tool to:
assign, for each respective security control of the set of security controls, an instance of the respective security control; and
configure each instance according the respective security control configuration; and
a controller to implement a path in a software defined network for the messages through the set of security control instances.

9. The system of claim 8, wherein the provisioning tool is to assign each instance of the respective security control by selecting an instantiated template virtual security control or by instantiating a stored template virtual security control.

10. The system of claim 8, wherein the provisioning tool is to instantiate a security control instance for the set of security control instances to satisfy only policy requirements for the corresponding security control.

11. The system of claim 8, further comprising:
a monitor to monitor flows implementing the path in the software defined network and the set of security control instances.

12. The system of claim 11, wherein the monitor is further to detect an increased message load and cause the provisioning tool to assign additional security control instances.

13. A non-transitory computer readable medium storing instructions executable to:
configure a first set of security control instances according to a first security configuration for a first endpoint;
configure a second set of security control instances according to a second security configuration for a second endpoint;
configure a software defined network to forward packets to the first endpoint through the first set of security control instances; and
configure the software defined network to forward packets to the second endpoint through the second set of security control instances.

14. The non-transitory computer readable medium of claim 13, wherein the first security configuration applies to communications from a third endpoint to the first endpoint; and the medium storing further instructions executable to:
configure a third set of security control instances according to a third security configuration for the first endpoint and a fourth endpoint; and
configure the software defined network to forward packets from the fourth endpoint to the first endpoint through the third set of security control instances.

15. The non-transitory computer readable medium of claim 13, storing further instructions to:
assign the first set of security control instances according to the first security configuration; and
assign the second set of security control instances according to the second security configuration.
